(19) United States
(12) Patent Application Publication
(10) Pub. No.: US 2022/0410347 A1
(43) Pub. Date: Dec. 29, 2022

(54) FLUID JET SYSTEMS AND METHODS OF USE TO ACCESS AND DISASSEMBLE COMPONENTS OF HAZARDOUS ARTICLES

(71) Applicant: Shape Technologies Group, Inc., Kent, WA (US)

(72) Inventors: Mohamed A. Hashish, Bellevue, WA (US); Dylan Howes, San Carlos, CA (US)

(21) Appl. No.: 17/851,699

(22) Filed: Jun. 28, 2022

Related U.S. Application Data
(60) Provisional application No. 63/216,307, filed on Jun. 29, 2021.

(51) Int. Cl. B24C 5/04; B24C 1/04

(52) U.S. Cl. CPC B24C 5/04; B24C 1/045

(57) ABSTRACT

Disclosed herein are components, systems, and methods for accessing and disassembling components of hazardous articles. A cutting head of a fluid jet system generates a fluid jet that exits an outlet toward a workpiece to be cut by the fluid jet. A shroud of the fluid jet system radially surrounds the outlet, and contains an inert substance through which the fluid jet travels between the outlet and the workpiece. A fluid jet system includes a sensor to capture an acoustic parameter of the impact of a fluid jet with a workpiece, and upon detection of a change in the acoustic parameter, discontinues generation of the fluid jet. A fluid jet system includes a sensor to measure thicknesses of various regions of the workpiece and a processor to select a path to cut the workpiece based on the measured thicknesses.

### BACKGROUND

### Technical Field

This disclosure relates to fluid jet systems and related methods, and more particularly, to the use of fluid jet systems that facilitate accessing and disassembling components of hazardous articles.

### Description of the Related Art

Waterjet or abrasive waterjet cutting systems are used for cutting a wide variety of materials, including stone, glass, ceramics, and metals. In a typical waterjet cutting system, high-pressure water flows through a cutting head having a nozzle which directs a cutting jet onto a workpiece. The system may draw or feed abrasive media into the high-pressure waterjet to form a high-pressure abrasive waterjet. One or both of the cutting head and the workpiece may then be controllably moved relative to the other of the cutting head and the workpiece to cut the workpiece as desired. Systems for generating high-pressure waterjets are currently available, such as, for example, the Mach 4 five-axis waterjet cutting system manufactured by Flow International Corporation. Other examples of waterjet cutting systems are shown and described in Flow's U.S. Pat. No. 5,643,058.

Abrasive waterjet cutting systems are advantageously used when cutting workpieces made of particularly hard materials to meet exacting standards. However, the use of abrasives introduces complexities, and abrasive waterjet cutting systems can suffer from other drawbacks, including the need to contain and manage spent abrasives. Known abrasive waterjet cutting systems may not be particularly well suited for cutting or machining some types of hazardous articles, such as batteries, which may contain components susceptible to heat and/or exposure to oxygen.

Thus, a need exists for systems and methods that enable accessing, disassembling, and recycling components of hazardous articles.

### BRIEF SUMMARY

Some hazardous articles, such as batteries (particularly Lithium-ion batteries), fail or are discarded after use. These articles may contain components, which are desirable to access and separate from the remainder of the article to enable recycling or safe disposal of said components. This disclosure provides fluid jet systems and methods of their use to open the articles and access and separate certain components, especially valuable metals, that can then be recycled.

According to one embodiment, a cutting head of a fluid jet system includes a nozzle and a shroud. The nozzle includes an orifice through which fluid passes to generate a fluid jet, and the nozzle further includes an outlet through which the fluid jet exits the cutting head toward a workpiece to be cut by the fluid jet. The shroud, in combination with the workpiece, at least partially encloses a region in which the outlet is positioned such that the shroud radially surrounds the outlet, and the region contains an inert substance through which the fluid jet travels between the outlet and the workpiece.

Additional embodiments described herein provide a method of operating a fluid jet system. The method includes positioning a shroud relative to a workpiece such that the shroud, in combination with the workpiece, at least partially encloses a region, at least partially filling the region with an inert substance, generating a fluid jet, discharging the fluid jet through an outlet of the fluid jet system, wherein the outlet is positioned within the region and radially surrounded by the shroud, directing the discharged fluid jet through the inert substance, and impinging the workpiece with the fluid jet.

Additional embodiments described herein provide a method of operating a fluid jet system, the method including generating a fluid jet with the fluid jet system, discharging the fluid jet toward a workpiece from a cutting head of the fluid jet system, drilling a hole in the workpiece with the fluid jet, while drilling the hole, monitoring at least one acoustic parameter produced by the fluid jet drilling the hole in the workpiece, and discontinuing generation of the fluid jet upon detection of a change in the at least one acoustic parameter.

Additional embodiments described herein provide a method of operating a fluid jet system, the method including scanning a workpiece to determine a thickness of a plurality of regions of the workpiece, identifying a target region to be isolated from a remainder of the workpiece, plotting a path along which to cut the workpiece, wherein the path prioritizes avoiding thicker regions of the workpiece over a shorter path around the target region, generating a fluid jet within a cutting head of the fluid jet system, and discharging the fluid jet from the cutting head while the cutting head follows the path isolate the target region from the remainder of the workpiece.

Additional embodiments described herein provide a method of operating a fluid jet system, the method including at least partially submerging a workpiece within a volume of fluid, lowering a temperature of the volume of fluid to a first temperature, after lowering the temperature to the first temperature, generating a fluid jet, discharging the fluid jet through an outlet of the fluid jet system, impinging the workpiece with the discharged fluid jet, and while impinging the workpiece with the discharged fluid jet, maintaining the volume of fluid at the first temperature.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is an isometric view of a fluid jet system, according to one embodiment.

FIG. 2 is a side, cross-sectional view of a cutting head assembly of the fluid jet system illustrated in FIG. 1, according to another embodiment.

FIG. 3 is a side, cross-sectional view of a portion of the cutting head assembly illustrated in FIG. 2 in use according to one embodiment.

FIG. 4 is a schematic view of a fluid jet system, according to one embodiment.

FIG. 5 is a side, cross-sectional view of a cutting head assembly and a sensor of the fluid jet system, in use at a moment in time, according to one embodiment.

FIG. 6 is a side, cross-sectional view of the cutting head assembly and the sensor illustrated in FIG. 5, in use at another moment in time, according to one embodiment.

FIG. 7 is a graph of at least one acoustic parameter captured by the sensor illustrated in FIG. 5 during a period of time.

FIG. 8 is another graph of at least one acoustic parameter captured by the sensor illustrated in FIG. 5 during a period of time.

FIG. 9 is a schematic view of sensor scanning a workpiece to identify regions of varying physical properties, according to one embodiment.

FIG. 10 is a side, cross-sectional view of a cutting head assembly of the fluid jet system illustrated in FIG. 1, according to another embodiment.

### DETAILED DESCRIPTION

In the following description, certain specific details are set forth to provide a thorough understanding of various disclosed embodiments. However, one skilled in the relevant art will recognize that embodiments may be practiced without one or more of these specific details, or with other methods, components, materials, etc. In other instances, well-known structures associated with high pressure waterjet systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For example, certain features of the disclosure which are described herein in the context of separate embodiments may also be provided in combination in a single embodiment. Conversely, various features of the disclosure that are described in the context of a single embodiment may also be provided separately or in any subcombination.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise. Reference herein to two elements “facing” or “facing toward” each other indicates that a straight line can be drawn from one of the elements to the other of the elements without contacting an intervening solid structure.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein.

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure. The term “cutting through” a structure refers to a complete removal of material through an entire thickness of the structure along the direction of impact of the cutting apparatus, for example the direction of travel of a waterjet just before it strikes a surface of the workpiece.

The headings and Abstract of the Disclosure provided herein are for convenience only and do not interpret the scope or meaning of the embodiments.

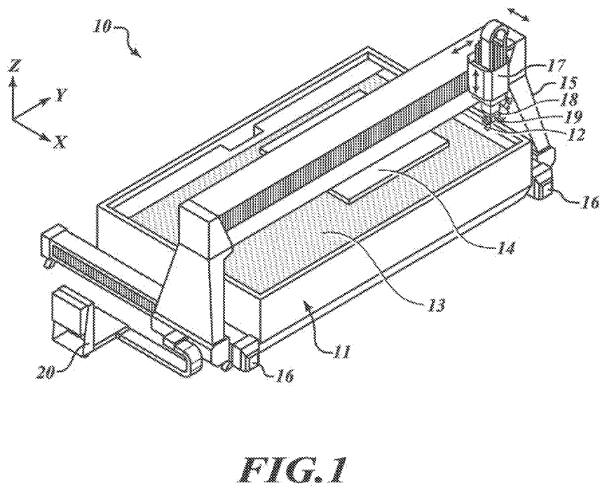

Referring to FIG. 1, a fluid jet system 10 (e.g., a system that generates a fluid jet to process (cut, drill, finish, etc.) a workpiece, such as a waterjet cutting system) may include a catcher tank assembly 11 having a work support surface 13 (e.g., an arrangement of slats) that is configured to support a workpiece 14 to be processed by the system 10. The fluid jet system 10 may further include a bridge assembly 15, which is movable along a pair of base rails 16 and straddles the catcher tank assembly 11. In operation, the bridge assembly 15 may move back and forth along the base rails 16 with respect to a translational axis X to position a cutting head assembly 12 of the system 10 that processes the workpiece 14.

A tool carriage 17 may be movably coupled to the bridge assembly 15 to translate back and forth along another translational axis Y, which is aligned perpendicularly to the aforementioned translational axis X. The tool carriage 17 may be configured to raise and lower the cutting head assembly 12 along yet another translational axis Z to move the cutting head assembly 12 toward and away from the workpiece 14 (and perpendicularly to both the translational axis X and the translational axis Y). One or more manipulable links or members may also be provided intermediate the cutting head assembly 12 and the tool carriage 17 to provide additional functionality.

As an example, the fluid jet system 10 may include a forearm 18 rotatably coupled to the tool carriage 17 to rotate the cutting head assembly 12 about an axis of rotation, and a wrist 19 rotatably coupled to the forearm 18 to rotate the cutting head assembly 12 about another axis of rotation that is nonparallel to the aforementioned rotational axis. In combination, the rotational axes of the forearm 18 and the wrist 19 can enable the cutting head assembly 12 to be manipulated in a wide range of orientations relative to the workpiece 14 to facilitate, for example, cutting of complex profiles. According to one embodiment, the system 10 may include a robotic arm (not shown), which carries the cutting head assembly 12 and is movable to position the cutting head assembly 12 relative to the workpiece 14, as desired.

The rotational axes may converge at a focal point which, in some embodiments, may be offset from the end or tip of a nozzle component of the cutting head assembly 12. The end or tip of the nozzle component of the cutting head assembly 12 may be positioned at a desired standoff distance from the workpiece 14 or work surface to be processed. The standoff distance may be selected or maintained at a desired distance to optimize the cutting performance of the waterjet. For example, in some embodiments, the standoff distance may be maintained at about 0.20 inch (5.1 mm) or less, or in some embodiments at about 0.10 inch (2.5 mm) or less. In other embodiments, the standoff distance may vary over the course of a trimming operation or during a cutting procedure, such as, for example, when piercing the workpiece.

In some instances, the nozzle component of the waterjet cutting head may be particularly slim or slender to enable, among other things, inclining of the nozzle component relative to the workpiece with minimal stand-off distance (e.g., a 30 degree inclination with standoff distance less than or equal to about 0.5 inch (12.7 mm)).

During operation, movement of the cutting head assembly 12 with respect to each of the translational axes and one or more rotational axes may be accomplished by various conventional drive components and an appropriate control system 20. The control system 20 may generally include, without limitation, one or more computing devices, such as processors, microprocessors, digital signal processors (DSP), application-specific integrated circuits (ASIC), and the like. To store information, the control system may also include one or more storage devices, such as volatile memory, non-volatile memory, read-only memory (ROM), random access memory (RAM), and the like. The storage devices can be coupled to the computing devices by one or more buses.

The control system may further include one or more input devices (e.g., displays, keyboards, touchpads, controller modules, or any other peripheral devices for user input) and output devices (e.g., display screens, light indicators, and the like). The control system 20 may store one or more programs for processing any number of different workpieces according to various cutting head movement instructions. The control system 20 may also control operation of other components, such as, for example, a secondary fluid source, a vacuum device and/or a pressurized gas source coupled to the pure waterjet cutting head assemblies and components described herein.

The control system 20, according to one embodiment, may be provided in the form of a general purpose computer system. The computer system may include components such as a CPU, various I/O components, storage, and memory. The I/O components may include a display, a network connection, a computer-readable media drive, and other I/O devices (a keyboard, a mouse, speakers, etc.). A control system manager program may be executing in memory, such as under control of the CPU, and may include functionality related to, among other things, routing high-pressure water through the waterjet cutting systems described herein, providing a flow of secondary fluid to adjust or modify the coherence of a discharged fluid jet and/or providing a pressurized gas stream to provide for unobstructed pure waterjet cutting of a fiber reinforced polymer composite workpiece.

Further example control methods and systems for waterjet cutting systems, which include, for example, CNC functionality, and which are applicable to the waterjet cutting systems described herein, are described in Flow's U.S. Pat. No. 6,766,216, which is incorporated herein by reference in its entirety. In general, computer-aided manufacturing (CAM) processes may be used to efficiently drive or control a waterjet cutting head along a designated path, such as by enabling two-dimensional or three-dimensional models of workpieces generated using computer-aided design (i.e., CAD models) to be used to generate code to drive the machines. For example, in some instances, a CAD model may be used to generate instructions to drive the appropriate controls and motors of a waterjet cutting system to manipulate the cutting head about various translational and/or rotational axes to cut or process a workpiece as reflected in the CAD model.

Details of the control system, conventional drive components and other well-known systems associated with waterjet cutting systems, however, are not shown or described in detail to avoid unnecessarily obscuring descriptions of the embodiments. Other known systems associated with waterjet cutting systems include, for example, a high-pressure fluid source (e.g., direct drive and intensifier pumps with pressure ratings ranging from about 60,000 psi to 110,000 psi and higher) to supply high-pressure fluid to the cutting head assembly 12.

According to some embodiments, the fluid jet system 10 may include a pump, such as, for example, a direct drive pump or intensifier pump (not shown), to selectively provide pressurized fluid (e.g., water) at an operating pressure of at least 10,000 psi (e.g., between about 10,000 psi and about 110,000 psi). The cutting head assembly 12 of the fluid jet system 10 may be configured to receive the pressurized fluid supplied by the pump and to generate a pressurized fluid jet (e.g., a waterjet) to process workpieces. A fluid distribution system (not shown) in fluid communication with the pump and the cutting head assembly 12 may be provided to assist in routing pressurized fluid from the pump to the cutting head assembly 12.

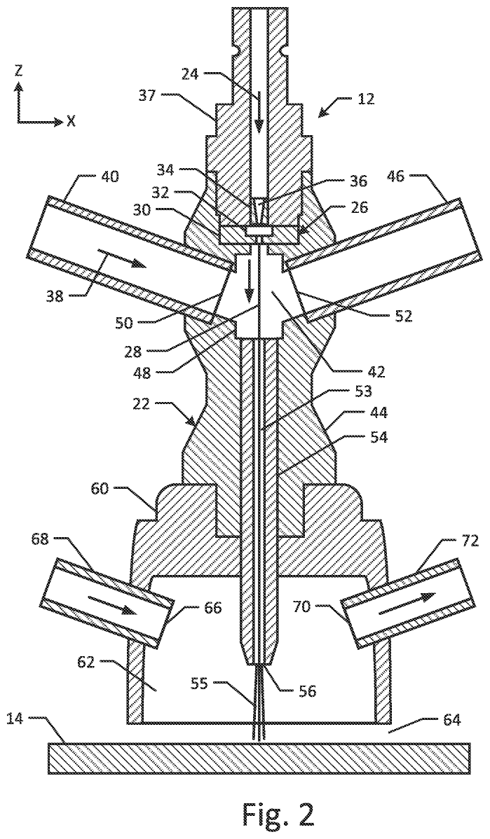

Referring to FIG. 2, the cutting head assembly 12 may include a nozzle 22. The nozzle 22 may be operable with ultrahigh pressure fluid (e.g., equal to or greater than about 80,000 psi (551 MPa)), high pressure fluid (e.g., between about 50,000 psi (345MPa) and about 80,000 psi (551 MPa)), medium pressure fluid (e.g., between about 30,000 psi (206 MPa) and about 50,000 psi (345 MPa)), low pressure fluid (e.g., between about 10,000 psi (69 MPa) and about 30,000 psi (206 MPa)), or combinations thereof.

Pressurized fluid 24 from a source (e.g., the pump) advances into the nozzle 22. The system 10 may include a jet generating assembly 26 that generates a fluid jet 28. The jet generating assembly 26 may include an orifice mount 30 and a jewel orifice 32. In some embodiments, the nozzle 22 may include a seal assembly 34. The seal assembly 34 may have a passageway 36 that tapers inwardly in the downstream direction so as to direct the pressurized fluid 24 into and through the jewel orifice 32.

As shown, the jet generating assembly 26 may produce the fluid jet 28 from the pressurized fluid 24 flowing through a feed conduit 37 of the nozzle 22. The jewel orifice 32 may produce the fluid jet 28 in which an abrasive 38, flowing through an abrasive port 40 of the nozzle 22, is entrained at a mixing region 42 (e.g., a mixing chamber). According to one embodiment, the cutting head assembly 12 may produce a pure water jet (i.e., one devoid of abrasives), and the system 10 may therefore be devoid of the abrasive port 40.

Various types of jewel orifices or other fluid jet producing devices can be used to achieve the desired flow characteristics of the fluid jet 28. The orifice mount 30 may be fixed with respect to a cutting head body 44 and include a recess (e.g., a disk-shaped recess) dimensioned to receive and to hold the jewel orifice 32.

The configuration and size of the orifice mount 30 may be selected based on the desired position of the jewel orifice 32. According to one embodiment, the orifice mount 30 may be disk-shaped and removably retained by the cutting head body 44, enabling removal and replacement of the orifice mount 30 as it approaches the end of its life cycle.

The nozzle 22 may include an auxiliary port 46 that provides passage for the introduction of a second substance or to allow the nozzle 22 to be connected to a pressurization source (e.g., a vacuum source, pump, etc.) or one or more sensors (e.g., pressure sensors). U.S. Publication No. 2003/0037650 and U.S. Pat. Nos. 6,875,084 and 5,643,058 disclose methods and devices that can be used with the ports 40, 46. U.S. Publication No. 2003/0037650 and U.S. Pat. Nos. 6,875,084 and 5,643,058 are incorporated by reference herein in their entireties. The cutting head body 44, may have a one-piece construction formed via a machining process (e.g., an injection molding process). The cutting head body 44 may be made, in whole or in part, of one or more metals (e.g., steel, aluminum, titanium, etc.) or metal alloys, according to one embodiment. The cutting head body 44 having a one-piece construction may result in the cutting head body 44 being less prone to malfunction.

As shown, an inner surface 48 of the cutting head body 44 may define the mixing region 42, an abrasive inlet 50 of the abrasive port 40, and an auxiliary inlet 52 of the auxiliary port 46. The abrasives 38 passing through the abrasive inlet 50 may be entrained in the fluid jet 28 as it passes through the mixing region 42. Entraining can include, without limitation, mixing, combining, or otherwise bringing together two or more different substances. For example, abrasives may be partially or fully mixed with the fluid forming the fluid jet such that the fluid jet carries the abrasives into and through a mixing tube 54, thereby forming an abrasive fluid jet 55. According to one embodiment, the abrasives 38 may make up less than 15% of the abrasive fluid jet 55 by volume.

The cutting head body 44 may include a recess sized to receive the mixing tube 54. According to one embodiment, the pressurized fluid 24 from the pump may be delivered to the jet generating assembly 26. The jewel orifice 32 produces the fluid jet 28 that passes through the mixing region 42. To form the abrasive fluid jet 55, the abrasives 38 delivered through the abrasive port 40 and into the mixing region 42 via the abrasive inlet 50, may be combined together and delivered through a channel 53 of the mixing tube 54. The abrasives 38 and the fluid jet 28 may be further mixed in the mixing tube 54 to produce the abrasive fluid jet 55, which exits via an outlet 56 of the nozzle 22 (e.g., a distal end of the mixing tube 54) and is directed to the workpiece 14 to process the workpiece 14.

The components of the cutting head assembly 12, such as mixing tubes, jewel orifices, and orifice mounts may be selected based on the operating parameters, such as working pressures, cutting action, and the like. The system 10 may include a valve assembly that selectively controls the flow of the pressurized fluid 24 into the nozzle 22. U.S. Publication No. 2003/0037650, incorporated by reference herein, discloses various types of valve assemblies that can be used with the illustrated nozzle 22. Other types of valve assemblies can also be used with the nozzle 22, if needed or desired.

According to one embodiment, the cutting head assembly 12 may include a shroud 60 that at least partially encloses a region 62. As shown, the shroud 60 may be positioned (e.g., carried by the cutting head body 44) such that the outlet 56 of the nozzle 22 is positioned within the region 62. For example, the distal end of the mixing tube 54 may be radially surrounded by the shroud 60 with respect to a longitudinal axis of the mixing tube 54.

During operation of the system 10, the shroud 60 may be positioned relative to the workpiece 14 such that the shroud 60 and the workpiece 14 cooperatively enclose the region 62. According to one embodiment, the shroud 60 and the workpiece 14 may be in direct contact to cooperatively enclose the region 62. The direct contact interface of the shroud 60 and the workpiece 14 may be sufficient to retain a pocket of gas (e.g., an inert gas) or a pocket of liquid (e.g., water) within the region 62 and prevent or substantially hinder entry of atmosphere air into the region 62.

According to one embodiment, the shroud 60 and the workpiece 14 may be in close proximity such that a gap 64 (e.g., a radial gap) is positioned between a surface (e.g., the “bottom”) of the shroud 60 that is closest to and faces the workpiece 14 and the workpiece 14 to cooperatively enclose the region 62. The shroud 60 may include a flexible material (e.g., rubber) so that upon impact of the shroud 60 with an object (e.g., a raised portion of the workpiece 14) during operation of the system 10, the shroud 60 will deform (e.g., elastically) to absorb the impact and enable continued operation of the system 10.

The shroud 60 may be carried by the cutting head assembly 12 (e.g., the nozzle 22) such that relative movement between the shroud 60 and the nozzle 22 is prevented, or at least limited. According to one embodiment, relative movement of the shroud 60 and the outlet 56 of the nozzle 22 is permitted in the vertical direction (i.e., toward and away from the workpiece 14), to enable the shroud to be “raised” and “lowered” to change the size of the gap 64. For example, the shroud 60 may be lowered to decrease the size of or eliminate the gap 64 when the system 10 is cutting a sensitive component of the workpiece 14, and an inert pocket is to be established in the region 62. After cutting the sensitive component, the shroud 60 may be raised, thereby increasing the size of the gap 64.

Thus, according to one embodiment, the shroud 60 may be supported by the cutting head assembly 12 such that as the nozzle 22 moves relative to the workpiece 14, the shroud 60 also moves, in unison, relative to the workpiece 14. This arrangement of the shroud 60 and the outlet 56 enables rapid and selective control of the region 62. During “normal” operation (i.e., when processing non-sensitive components of the workpiece 14), atmosphere air may be present in the region 62. When the cutting head assembly 12 is about to begin processing a sensitive component of the workpiece 14, the air in the region 62 may be replaced with an inert environment, as will be described in detail below. After processing the sensitive component of the workpiece 14, “normal” operation may resume with the inert environment subsiding within the region 62, and air once again returning.

The shroud 60 may include an entrance 66 into the region 62 through which an inert substance travels to form the inert environment. The entrance 66 may be formed by a first shroud port 68. The first shroud port 68 may be a tubular member that carries gas (e.g., an inert gas such as nitrogen, carbon dioxide, etc.), fluid (e.g., an inert fluid, for example water or water with an additive, such as a long chain polymer), or both into the region 62. According to one embodiment, the first shroud port 68 may be in communication with a source (e.g., a source of an inert gas) that supplies the inert substance to the region 62.

The shroud 60 may include an exit 70 through which a substance within the region 62 may be evacuated. The exit 70 may be formed by a second shroud port 72. The second shroud port 72 may be a tubular member that carries gas (e.g., an inert gas such as nitrogen, carbon dioxide, etc.), fluid, or both that are present within the region 62. According to one embodiment, the second shroud port 72 may be in communication with a source (e.g., a source of vacuum) that assists in the removal of the substance(s) within the region 62.

According to one embodiment, the shroud 60 may include only one port (e.g., only the first shroud port 68 and not the second shroud port 72), and that one port may function as both the entrance 66 and the exit 70 for the region 62. For example, a valve may be coupled to the one port and the control of the valve may transition the one port from functioning as an entrance 66 to an exit 70, or vice versa. According to one embodiment, the gap 64 may form the exit 70, such that as a substance enters the region 62 through the entrance 66, the substance that was present in the region 62 prior to entrance of the substance exits through the gap 64.

According to one embodiment, the shroud 60 may be devoid of any ports. Instead, the outlet 56 of the nozzle 22 may function as the entrance 66 and the gap 64 may function as the exit 70. The inert environment may be formed by a substance (e.g., an inert gas) that enters the region 62 through the outlet 56. According to one embodiment, the abrasives 38 may be carried to the mixing region 42 by the substance, which then travels through the mixing tube 54 and enters the region 62 via the outlet 56.

One potential danger of processing a hazardous article (e.g., a battery such as a lithium-ion battery) is thermal runaway of a sensitive component (e.g., uncontrolled rapid heating of the battery created by positive feedback between battery cell temperature and conductivity of the electrolyte in the battery). Thermal runaway may result in ignition of the article. One solution to prevent the ignition of a hazardous article is to form an inert environment (e.g., within the region 62) in which the produced fluid jet (e.g., the abrasive fluid jet 55) exits the nozzle 22 and processes the workpiece 14. The inert environment is one in which ignition of the workpiece 14 is prevented or at least inhibited. According to one embodiment, the inert environment may be oxygen-deprived (e.g., containing a lower percentage of oxygen than ambient atmosphere). According to one embodiment, the inert environment may include an inert gas (e.g., nitrogen, carbon dioxide, etc.), fluid (e.g., an inert fluid), or both positioned within the region 62.

Other hazardous articles include, but are not limited to, munitions (e.g., rockets with propellants) and tanks containing hazardous gasses (e.g., used during welding and construction). The hazardous articles may contain materials or substances that react to a spark and explode or combust as a result. The inert environment may prevent or lower the potential for spark generation, and/or may provide an oxygen-deprived environment in which ignition is prevented or at least inhibited.

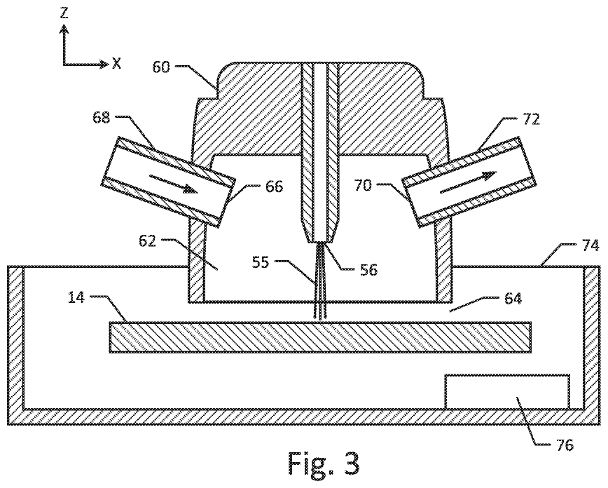

According to one embodiment a method of operating the fluid jet system 10 includes positioning the shroud 60 relative to the workpiece 14 such that the shroud 60, in combination with the workpiece 14, encloses (e.g., at least partially encloses) the region 62. The method may further include at least partially filling the region 62 with an inert material (e.g., via the entrance 66). The method may include generating a fluid jet (e.g., the abrasive fluid jet 55) and discharging the fluid jet through the outlet 56 of the nozzle 22, with the outlet 56 positioned within the region 62. The method may include directing the discharged fluid jet through the inert material, and impinging the workpiece 14 with the fluid jet. Referring to FIG. 3, the catcher tank assembly 11 may be filled with a fluid 74 (e.g., water). According to one embodiment the method may include submerging at least a portion of the workpiece 14 and at least a portion of the shroud 60 in the fluid 74. The method may further include capturing a pocket of an inert substance (e.g., an inert gas) within the region 62. The gap 64 may be occupied by the fluid 74, thereby preventing the pocket of the inert substance from exiting through the gap 64. According to one embodiment, the shroud 60 may directly contact the workpiece 14 to form a barrier that prevents exit of the inert substance out of the region 62 via the interface between the shroud 60 and the workpiece 14.

The catcher tank assembly 11 may include a cooler 76 that influences the temperature of the fluid 74. Operation of the fluid jet system 10 (e.g., discharge of the abrasive fluid jet 55 into the fluid 74) may result in an increase of a temperature of the fluid 74. When processing certain hazardous articles, preventing a temperature increase of the working environment may reduce the likelihood of ignition of the sensitive components of the hazardous articles. According to one embodiment, a method of operating the system 10 may include activating the cooler 76 to lower the temperature of the fluid 74 below its ambient temperature.

According to one embodiment, a method of operating the system 10 may include cyclically activating the cooler 76 to maintain a desired temperature of the fluid 74. For example, the desired temperature of the fluid 74 may be the ambient temperature (i.e., resting temperature, or temperature absent any effect of operation of the system 10). Thus, the cooler 76 may be operable to maintain the ambient temperature of the fluid 74. During operation of the system 10, heat is gradually generated/added to the fluid 74, the cooler 76 activates to remove heat from the fluid 74 and maintain the desired temperature.

The cooler 76 may operate as a heat sink, removing heat from the fluid 74 by a separate coolant that remains separate from the fluid 74. According to one embodiment, the cooler 76 may cycle fluid 74 out of the catcher tank assembly 11, to a heat exchanger where heat is removed from the fluid 74, and then cycle the now cooled fluid 74 back to the catcher tank assembly 11. The workpiece 14 may be supported on an actively cooled structure, such as one or more hollow beams with a cooling fluid circulating through the interior of the beams.

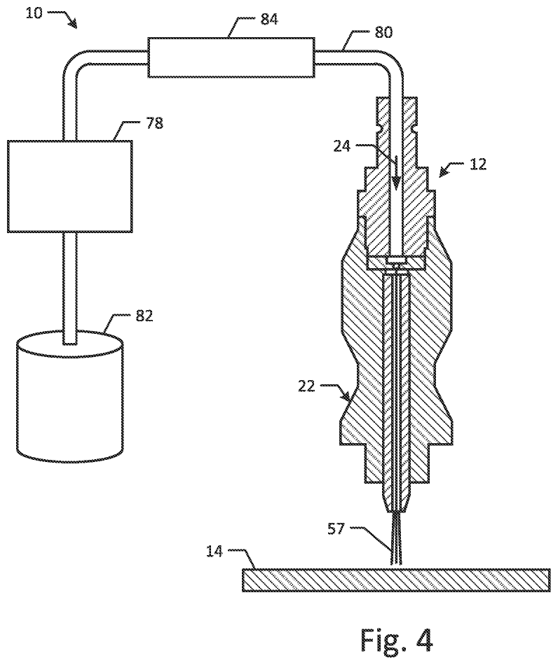

Referring to FIG. 4, the fluid jet system 10 may include a pump 78, such as, for example, a direct drive pump or intensifier pump, to selectively provide the pressurized fluid 24 (e.g., water) at an operating pressure of at least 10,000 psi (e.g., between about 10,000 psi and about 110,000 psi) to the cutting head assembly 12. A fluid distribution system 80 may fluidly connect a source 82 (e.g., a tank) of the fluid with the pump 78 and with the cutting head assembly 12.

The system 10 may include an upstream cooler 84 between the source 82 and the cutting head assembly 12. The upstream cooler 84 may lower the temperature of the fluid prior to reaching the cutting head assembly 12. According to one embodiment, the upstream cooler 84 may be positioned between the pump 78 and the cutting head assembly 12, as shown, such that the upstream cooler 84 lowers the temperature of the fluid after it has been pressurized. For example, liquid nitrogen may be used to cool the pressurized water without freezing the pressurized water.

According to one embodiment, the upstream cooler 84 may be positioned between the source 82 and the pump 78 such that the upstream cooler 84 lowers the temperature of the fluid prior to its pressurization. According to one embodiment, the system 10 may include multiple upstream coolers 84 (e.g., one positioned between the pump 78 and the cutting head assembly 12 and another positioned between the source 82 and the pump 78).

As shown, the cutting head assembly 12 of the system 10 may produce a pure fluid jet 57 (i.e., a fluid jet devoid of abrasives). Thus, the system 10 may be devoid of one or both of the abrasive port 40 and the auxiliary port 46. Similarly, the cutting head assembly 12 may be devoid of the shroud 60. The system 10 may include either the cooler 76 or the upstream cooler(s) 84, both the cooler 76 and the upstream cooler(s) 84, or neither the cooler 76 and the upstream cooler(s) 84.

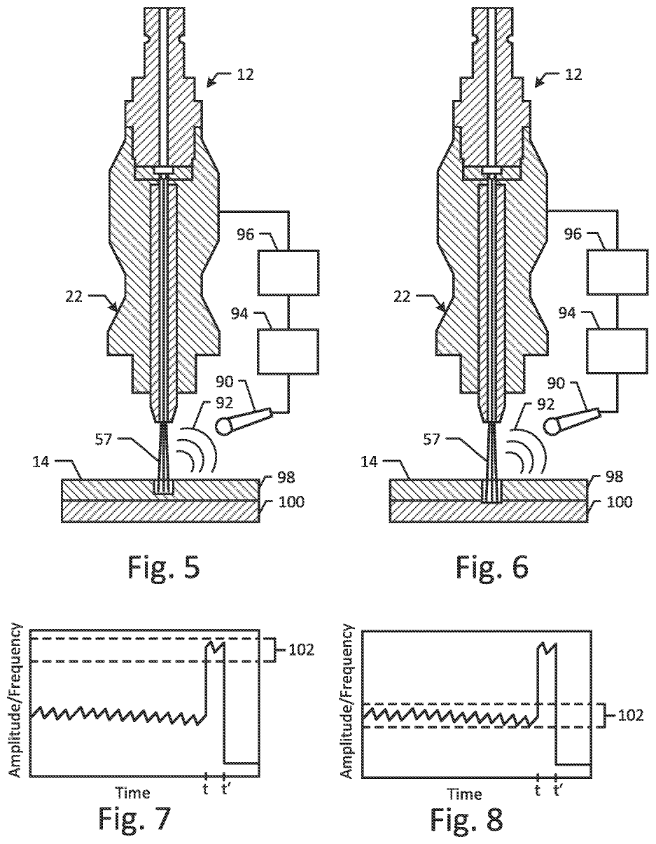

Referring to FIGS. 5 to 8, the system 10 may include a sensor 90 (e.g., a microphone) that captures an acoustic parameter 92 of the system 10 while processing the workpiece 14. The acoustic parameter 92 may be generated by the impact of the fluid jet (e.g., the abrasive fluid jet 55 or the pure fluid jet 57) produced by the cutting head assembly 12 with the workpiece 14. According to one embodiment, the acoustic parameter 92 may include the frequency, the amplitude, or both the frequency and the amplitude produced by the impact of the fluid jet with the workpiece 14.

Different materials within the workpiece 14 may produce different acoustic parameters 92 when impacted by the fluid jet. According to one embodiment, the system 10 may include a processor 94 that analyzes the acoustic parameter 92 captured by the sensor 90. Upon identification of the fluid jet impacting a desired material (e.g., a valuable material that is to be recycled) a controller 96 of the system 10 may disable the production of the fluid jet.

As shown in the illustrated embodiment, the pure fluid jet 57 may process (e.g., drill a hole) in the workpiece 14. The workpiece 14 may include two, different materials (a first material 98 and a second material 100). For this example the second material 100 is a valuable material to be recycled (e.g., cobalt, nickel, copper, aluminum, graphite, manganese, lithium) and the first material 98 is a scrap material.

As the fluid jet impacts the first material 98 at least one acoustic parameter 92 is captured by the sensor 90. Upon impact of the fluid jet with the second material 100, as shown in FIG. 6, the acoustic parameter 92 may enter a target range 102, as shown in FIG. 7, at time t. Upon detection of the acoustic parameter 92 entering the target range 102 (e.g., for a set number of cycles to ensure the reading is not an anomaly), the controller 96 deactivates the production of the fluid jet, at time t′. According to one embodiment, the deactivation may be achieved by turning off the flow of pressurized fluid 24 (e.g., via actuation of a shut-off valve).

The controller 96 may identify impact of the fluid jet with any of a plurality of desired materials via the acoustic parameter 92 entering one of a plurality of target ranges, and upon such identification deactivate the production of the fluid jet. Thus, according to one embodiment, the system 10 may be programed with a plurality of target ranges 102 that correspond to various combinations of fluid jet impacting various materials. For example, a first target range 102 may indicate impact of a pure water jet at a pressure of 60,000 psi with cobalt, a second target range 102 may indicate impact of an abrasive water jet at a pressure of 60,000 psi with cobalt. Upon selection of the operating parameters (e.g., type of fluid jet, use of abrasives, operating pressure, etc.) a set of target ranges 102 that correspond to the operating parameters may be identified. According to one embodiment, the sensor 90 may be positioned inside the region 62.

The sensor 90 may be used during a cutting procedure similarly to the description above for the drilling procedure. As the fluid jet (e.g., the pure fluid jet 57) cuts through the first material 98 of the workpiece 14, the acoustic parameter 92 is within a first range (e.g., outside the target range 102). As the fluid jet impacts the second material 100 of the workpiece 14, the acoustic parameter 92 changes and enters the target range 102. Upon detection of the acoustic parameter 92 entering the target range 102, the controller 96 may deactivate the fluid jet, thus preserving the second material 100.

As shown in FIG. 8, the system 10 may operate such that the target range 102 corresponds to the acoustic parameter 92 of the fluid jet impacting a first, known material of the workpiece 14. For example, the system 10 may be used to pierce an outer casing of a battery to access internal components of the battery. The material of the outer casing may be known, and thus the acoustic parameter 92 of the fluid jet impacting the outer casing the workpiece 14 defines the target range 102. Once the outer casing is pierced and the fluid jet impacts a material other than the outer casing, the acoustic parameter 92 exits the target range 102 and upon identification of the acoustic parameter 92 exiting the target range 102, the controller 96 may deactivate the fluid jet.

According to one embodiment, the frequency produced by the impact of the fluid jet with one of the materials of the workpiece 14 may be between 22.5 kHz and 23.5 kHz. According to one embodiment, upon impact of another of the materials of the workpiece 14, the frequency produced by the impact of the fluid jet with another of the materials of the workpiece 14 may change by at least 5 percent.

According to one embodiment, the amplitude of the acoustic parameter 92 from impact of the fluid jet with one material of the workpiece 14 may be between 88 to 92 dB, and impact of the fluid jet with another material of the workpiece 14 may change by at least 5 percent (e.g. to be between 98 to 102 dB).

A method of operating the system 10 may include generating a fluid jet (e.g., the abrasive fluid jet 55 or the pure fluid jet 57), and discharging the fluid jet from nozzle 22 toward the workpiece 14. The method may further include drilling a hole in the workpiece with the fluid jet, and while drilling the hole, monitoring the at least one acoustic parameter 92 produced by the fluid jet impacting the workpiece. The method may further include terminating the generation of the fluid jet upon detecting a change in the at least one acoustic parameter 92. According to one embodiment, the change in the at least one acoustic parameter 92 includes the value for the acoustic parameter 92 entering the target range 102. According to one embodiment, the change in the at least one acoustic parameter 92 includes the value for the acoustic parameter 92 exiting the target range 102.

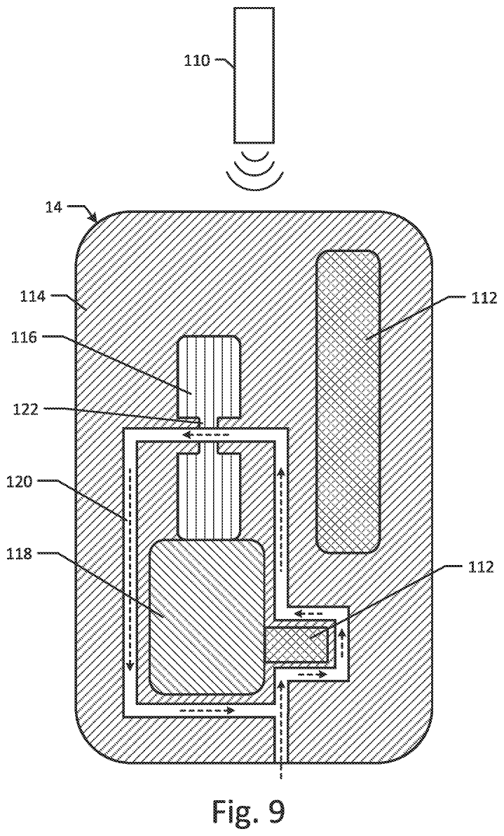

Referring to FIG. 9, the system 10 may include a sensor 110 that measures one or more physical properties (e.g., thickness, density, etc.) of the workpiece 14. According to one embodiment, the sensor 110 is an ultrasound imager. The sensor 110 may identify regions of the workpiece with different physical properties. As shown, the sensor 110 may identify regions of different thicknesses of the workpiece 14.

For example, the sensor 110, after scanning the workpiece 14, may identify one or more regions of greater thickness 112, one or more regions of lesser thickness 114, and one or more regions of intermediate thickness 116. According to one embodiment, the sensor 110 may also identify a target region 118 with a component or material that is to be isolated from the remainder of the workpiece 14.

The system 10 (e.g., a processor) may analyze data related to the physical properties of the workpiece 14, and identify a path 120 along which to cut the workpiece 14 to isolate the target region 118 from a remainder of the workpiece 14. As shown, the path 120 may avoid the one or more regions of greater thickness 112, deviating from the shortest path around the target region 118 to avoid passing through the one or more regions of greater thickness 112. According to one embodiment, the path 120 may avoid the one or more regions of lesser thickness 114 (or one or more regions of a certain thickness), deviating from the shortest path around the target region 118 to avoid passing through the one or more regions of lesser thickness 114, as these regions may contain a hazardous or valuable material.

Also as shown, the path 120 may minimize the distance traversing the one or more regions of intermediate thickness 116, deviating from the shortest path around the target region 118 to pass through a portion 122 of the one or more regions of intermediate thickness 116 with a reduced width.

A method of operating the system 10 may include scanning the workpiece 14 (e.g., with the sensor 110, for example an ultrasound imager) to determine thicknesses of various regions of the workpiece 14. The method may further include identifying the path 120 along which to cut the workpiece 14, the path 120 determined by prioritizing thinner sections of the workpiece 14 over thicker sections of the workpiece 14. For example, cutting a section (e.g., a T-shaped section) may include adjusting the position and/or orientation of the workpiece 14 on the support surface 13 such that the fluid jet cuts the thin side of the T-shaped section instead of cutting through the thick side.

The method may further include generating the fluid jet within the cutting head assembly 12 of the fluid jet system 10, and discharging the fluid jet from the nozzle 22 while following the path 120 to cut the workpiece 14. According to one embodiment, the method may include identifying the target region 118 and the path 120 is selected so as to isolate the target region 118 from the remainder of the workpiece 14.

The system 10 may be adjustable such that one or more of the parameters of the fluid jet generated by the cutting head assembly 12 are adjustable. For example, the pressure of the fluid jet, use of abrasives/type of abrasives, etc. may be selected based upon the one or more physical properties of the workpiece 14 located along the path 120. According to one embodiment, the one or more parameters of the fluid jet generated by the cutting head assembly 12 may be selected such that the fluid jet has sufficient power to cut through a first material (e.g., a plastic housing or bracket) of the workpiece 14, and lacks sufficient power to cut through a second material (e.g., a precious metal) located “beneath” (with respect to the fluid jet) the first material. Thus, the path 120 may be selected to overlap with the target region 118, while isolating the second material within the target region 118 from the remainder of the workpiece 14, without cutting through the second material.

According to one embodiment, the fluid jet produced by the cutting head assembly 12 may have an operating pressure of 60,000, while using garnet as an abrasive with a feed rate of 1 lb/min to have sufficient power to cut through 0.5 inch thick metal while having insufficient power to cut through 6 inch thick metal.

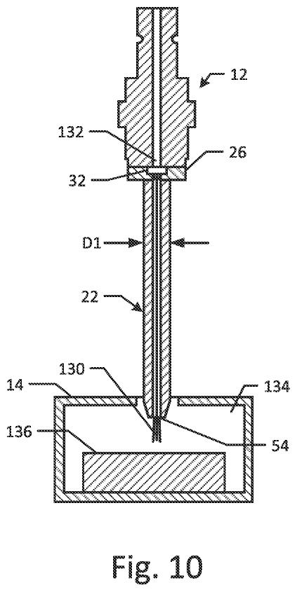

Referring to FIG. 10 the system 10 may generate an abrasive slurry jet 130 to process the workpiece 14. To produce the abrasive slurry jet 130 abrasives may be pre-mixed with pressurized fluid to form a slurry 132, such that the slurry 132 is delivered to the jet generating assembly 26. As the slurry 132 passes through the jewel orifice 32, the abrasive slurry jet 130 is generated. Because the abrasives are pre-mixed, components such as the mixing region 42 and the abrasive port 40 are not needed downstream of the jewel orifice 32. This may result in the nozzle 22 having a low-profile (e.g., a narrow cross-sectional dimension D1 measured in a plane perpendicular to the direction of travel of the abrasive slurry jet 130, for example less than 0.5 inches).

The low-profile nozzle 22 may then be inserted into an interior 134 of the workpiece 14. According to one embodiment, the interior 134 may include a hazardous component 136, which may be processed by the abrasive slurry jet 130 as the outlet 56 of the nozzle 22 is positioned within the interior 134 of the workpiece 14. According to one embodiment, the interior 134 may contain a gaseous hazardous component 136. The abrasive slurry jet 130 may be discharged through the outlet 54 similar to the abrasive fluid jet 55 and the pure fluid jet 57 when the outlet 54 is positioned within the region 62 of the shroud 60 as described in earlier embodiments.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The various embodiments described above can be combined to provide further embodiments.

Many of the methods described herein can be performed with variations. For example, many of the methods may include additional acts, omit some acts, and/or perform acts in a different order than as illustrated or described.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A cutting head of a fluid jet system, the cutting head comprising:
a nozzle including an orifice through which fluid passes to generate a fluid jet, the nozzle further including an outlet through which the fluid jet exits the cutting head toward a workpiece to be cut by the fluid jet; and
a shroud that in combination with the workpiece at least partially encloses a region in which the outlet is positioned such that the shroud radially surrounds the outlet,
wherein the region contains an inert substance through which the fluid jet travels between the outlet and the workpiece.

2. The cutting head of claim 1 wherein the shroud is carried by the nozzle such that as the cutting head moves relative to the workpiece, the shroud also moves relative to the workpiece.

3. The cutting head of claim 1 wherein the shroud includes an entrance into the region through which the inert substance travels.

4. The cutting head of claim 3 wherein the shroud includes an exit through which a non-inert substance within the region is evacuated prior to entrance of the inert substance.

5. The cutting head of claim 1 wherein the shroud includes an exit through which a non-inert substance within the region is evacuated prior to entrance of the inert substance.

6. The cutting head of claim 1, wherein the shroud is separated from the workpiece by a gap.

7. The cutting head of claim 1, wherein the shroud contacts the workpiece to form a liquid-tight barrier.

8. The cutting head of claim 1 wherein the fluid jet is a mixture of fluid and abrasive particles, the abrasive particles making up less than 15% by volume of the fluid jet.

9. The cutting head of claim 8 wherein the abrasives are pre-mixed with the fluid prior to pressurization of the fluid by a pump, and the pump pressurizes the fluid and abrasive mixture prior to the fluid passing through the orifice.

10. The cutting head of claim 8, further comprising a mixing chamber having an abrasive inlet port in through which the abrasives enter to mix with the fluid jet to form an abrasive fluid jet.

11. A method of operating a fluid jet system, the method comprising:
positioning a shroud relative to a workpiece such that the shroud, in combination with the workpiece, at least partially encloses a region;
at least partially filling the region with an inert substance;
generating a fluid jet;
discharging the fluid jet through an outlet of the fluid jet system, wherein the outlet is positioned within the region and radially surrounded by the shroud;
directing the discharged fluid jet through the inert substance; and
impinging the workpiece with the fluid jet.

12. The method of claim 11, further comprising:
submerging at least a portion of the workpiece and at least a portion of the shroud in a volume of fluid.

13. The method of claim 12, wherein positioning the shroud relative to the workpiece includes forming a gap between a bottom of the shroud and a top of the workpiece, and wherein submerging at least a portion of the shroud in the volume of fluid includes filling the gap with the fluid thereby capturing a pocket of inert gas within the region.

14. The method of claim 11, further comprising:
mixing abrasive particles with a fluid to form a slurry; and
pressurizing the slurry,
wherein generating the fluid jet includes passing the pressurized slurry through an orifice to generate an abrasive slurry jet.

15. The method of claim 11, further comprising:
pressurizing a fluid; and
mixing abrasive particles with the pressurized fluid to form a slurry,
wherein generating the fluid jet includes passing the slurry through an orifice to generate an abrasive slurry jet.

16. A method of operating a fluid jet system, the method comprising:
generating a fluid jet with the fluid jet system;
discharging the fluid jet toward a workpiece from a cutting head of the fluid jet system;
drilling a hole in the workpiece with the fluid jet;
while drilling the hole, monitoring at least one acoustic parameter produced by the fluid jet drilling the hole in the workpiece; and
discontinuing generation of the fluid jet upon detection of a change in the at least one acoustic parameter.

17. The method of claim 16 wherein the hole is drilled in a first material of the workpiece, and the change in the at least one acoustic parameter is produced when the fluid jet no longer contacts the first material.

18. The method of claim 17 wherein the change in the at least one acoustic parameter includes entry of the at least one acoustic parameter into a target range.

19. The method of claim 17 wherein the change in the at least one acoustic parameter includes exit of the at least one acoustic parameter from a target range.

20. The method of claim 16 wherein the at least one acoustic parameter includes a frequency, an amplitude, or both of a sound generated by impact of the fluid jet with the workpiece.

21. The method of claim 16, further comprising:
prior to generating the fluid jet, identifying a hazardous component of the workpiece; and
prior to discharging the fluid jet, aligning the hazardous component with an outlet of the cutting head through which the fluid jet is discharged,
wherein drilling the hole in the workpiece with the fluid jet includes drilling through a housing that encloses the hazardous component.

22. The method of claim 21, further comprising:
prior to discontinuing generation of the fluid jet, piercing the housing thereby exposing the hazardous component.

23. The method of claim 16, further comprising:
prior to generating the fluid jet, identifying a hazardous component of the workpiece; and
while discharging the fluid jet, keeping the hazardous component out of alignment with an outlet of the cutting head through which the fluid jet is discharged.

24. The method of claim 21 wherein identifying the hazardous component includes consulting technical information about the workpiece.

25. A method of operating a fluid jet system, the method comprising:
scanning a workpiece to determine a thickness of a plurality of regions of the workpiece;
identifying a target region to be isolated from a remainder of the workpiece;
plotting a path along which to cut the workpiece, wherein the path prioritizes avoiding thicker regions of the workpiece over a shorter path around the target region;
generating a fluid jet within a cutting head of the fluid jet system; and
discharging the fluid jet from the cutting head while the cutting head follows the path isolate the target region from the remainder of the workpiece.

26. The method of claim 25, wherein the path intersects both a first material of the workpiece and a second material of the workpiece, the method further comprising:
generating the fluid jet with sufficient power to cut through the first material and insufficient power to cut through the second material.

27. The method of claim 25 wherein scanning the workpiece includes generating an ultrasound image of the workpiece.

28. A method of operating a fluid jet system, the method comprising:
at least partially submerging a workpiece within a volume of fluid;
lowering a temperature of the volume of fluid to a first temperature;
after lowering the temperature to the first temperature, generating a fluid jet;
discharging the fluid jet through an outlet of the fluid jet system;
impinging the workpiece with the discharged fluid jet; and
while impinging the workpiece with the discharged fluid jet, maintaining the volume of fluid at the first temperature.

29. The method of claim 28, further comprising:
lowering a temperature of the fluid used to generate the fluid jet.

30. A method of operating a slurry jet system comprising:
mixing abrasives and fluid to form an abrasive slurry;
passing the abrasive slurry through an orifice of a cutting head to generate an abrasive slurry jet;
positioning an outlet of the cutting head within an interior space of a workpiece that encloses a hazardous component; and
discharging the abrasive slurry jet through the outlet and impinging the abrasive slurry jet with a portion of the workpiece enclosed within the interior space.
